(19) United States
(12) Patent Application Publication
(10) Pub. No.: US 2003/0004878 A1
(43) Pub. Date: Jan. 2, 2003

(54) Atm placement fee determination method, service providing system, financing system, automated transaction machine, automated financial transaction machine, and recording medium in which atm placement fee determination program is recorded

(75) Inventors: Kazuhiro Akutsu, Maebashi (JP); Kiyotaka Awatsu, Kawasaki (JP); Hidehiko Yamamoto, Kawasaki (JP)

Correspondence Address: STAAS & HALSEY LLP, 700 11TH STREET, NW, SUITE 500, WASHINGTON, DC, 20001, US

(73) Assignee: Fujitsu Limited of Kawasaki, Japan

(21) Appl. No.: 09/993,616

(22) Filed: Nov. 27, 2001

(30) Foreign Application Priority Data
Jul. 2, 2001 (JP) 2001-200945

(51) Int. Cl. G06F 17/60

(52) U.S. Cl. 705/43

(57) ABSTRACT

A service providing system includes an automated transaction machine (ATM), installed in a nonbank location of a fee recipient entity under a payment-by-results contract with a service provider, a history information obtaining unit for obtaining electronic history information of the ATM, and an ATM placement fee determination unit, operatively connected with the history information obtaining unit, for determining an ATM placement fee, which is to be paid to the fee recipient entity, based on the electronic history information obtained in the history information obtaining unit. In the service providing system, an ATM placement fee is fairly determined based on contribution to the service provider, such as the number of transactions performed on the individual ATM, and the fee recipient entity keenly tries to keep the ATM in proper condition for service.

### BACKGROUND OF THE INVENTION

1. Field of the Invention

The present invention relates to an automated transaction machine (hereinafter called an ATM) placement fee determination method, a service providing system, a financing system, an automated transaction machine, an automated financial transaction machine, and a recording medium in which an ATM placement fee determination program is recorded, and more particularly to determination of a placement fee for an automated teller machine installed in a retail store or the like.

2. Description of the Related Art

Since placement of automatic teller machines has been less restricted due to recent financial deregulation, more automated teller machines of financial institutions have been installed in nonbank locations (e.g., in retail stores). Conventionally, an individual financial institution, which installs automated teller machines in retail stores, pays the retail stores an equal placement fee for each of the installed automated teller machines.

Since such placement fees over a predetermined time period are the same for all automated teller machines installed in retail stores, an individual financial institution pays identical placement fees for all installed automated teller machines irrespective of the total number of transactions performed on the respective automated teller machines or the like. In other words, a placement fee for an automated teller machine on which a large number of transactions are performed is the same as that for another automated teller machine with a much smaller number of transactions.

An automated teller machine with a larger number of customer transactions, however, enhances the business of the financial institution. Thus, a retail store, in which an automated teller machine with a large number of transactions is installed, may complain about the unfairness of paying the same placement fee as that for an automated teller machine on which a smaller number of transactions is performed.

Since it is uneconomical for a financial institution to pay an unreasonable placement fee for automated teller machines on which a smaller number of transactions are performed, the financial institution may be tempted to remove the automated teller machine rather than pay such an unreasonable placement fee.

Further, since conventional placement fees that are to be paid to retail stores are set regardless of the working conditions of an individual automated teller machine, the retail stores are inclined to pay little attention to the condition of automated teller machines. Even when automated teller machines halt due to absence of bills or consumption items (paper for receipt), managers and clerks at retail stores may be reluctant to load the automated teller machines with bills or other consumption or and request the financial institutions or a working agent to load the automated teller machines with bills or the consumption items, thereby keeping the automated teller machines out-of-service for an extended length of time.

### SUMMARY OF THE INVENTION

With the foregoing problems in view, it is a first object of the present invention to provide an ATM placement fee determination method for determining fair ATM (automated transaction machine) placement fees to be paid to respective fee recipient entities based on contribution of an individual ATM, using, for example, the total number of transactions that customers performed on the individual ATM so that the ATM have been kept in proper condition for service. It is a second object to provide a computer-readable recording medium in which an ATM placement fee determination program method for determining fair ATM (automated transaction machine) placement fees to be paid to respective fee recipient entities based on contribution of an individual ATM is recorded so that the ATMs are kept in proper condition for service. It is a third object to provide a service system and a financing system for determining fair ATM (automated transaction machine) placement fees to be paid to respective fee recipient entities based on contribution of an individual ATM so that the ATMs have been kept in proper condition for service. It is a fourth object to provide an automated teller machine (ATM) and an automated financial transaction machine (AFTM) for which placement fees to be paid to fee recipient entity are fairly determined the based on contribution of an individual ATM or AFTM so that the ATM and the AFTM have been kept in proper condition for service.

To attain the above-mentioned first object, as a first generic feature, there is provided an automated transaction machine (ATM) placement fee determination method for determining an ATM placement fee to be paid to a fee recipient entity in a nonbank location in which an ATM is installed under a payment-by-results contract with a service provider, comprising the steps of: (a) obtaining electronic history information of the ATM; and (b) determining the ATM placement fee, which is to be paid to the fee recipient entity, in a computer-implemented way based on the electronic history information obtained by the obtaining step (a).

As a preferable feature, the electronic history information may be a transaction history about one or more transactions that have been performed on the ATM, or may be a maintenance history of one or more maintenance operations that have been performed by the fee reception entity. As a further preferable feature, the ATM may be an automated financial transaction machine (AFTM).

As an additional feature, the transaction history may be defined in terms of the number of transactions that have been performed on the ATM, the total sum of money that has been transacted on the ATM during the individual transactions, and/or in terms of the total length of time during which the ATM has been kept in proper condition for service. As additional further preferable feature, the electronic history information may be a browsing history about browsing web contents on the Internet as the ATM has been used by individual customers.

As a further preferable feature, the maintenance history may be an item loading history of loading the ATM with a consumption item by the fee reception entity, may be a problem solving history of solving one or more problems, which arose with respect to the ATM, by the fee reception entity, or may be a money loading history of loading the ATM with money by the fee reception entity.

As still further preferable feature, the money loading history may be defined in terms of the total number of banknotes that have been loaded in the ATM by the fee recipient entity or the total sum of money that has been loaded in the ATM by the fee recipient entity.

To accomplish the above-mentioned second object, as the second generic feature, there is provided a service providing system comprising: (a) an automated transaction machine (ATM), installed in a nonbank location of a fee recipient entity under a payment-by-results contract with a service provider, for providing services to individual customers upon their requests in a computer-implemented way; (b) a history information obtaining unit for obtaining electronic history information of the ATM; and (c) an ATM placement fee determination unit, operatively connected with the history information obtaining unit, for determining an ATM placement fee, which is to be paid to the fee recipient entity, in a computer-implemented way based on the electronic history information obtained in the history information obtaining unit.

As a third generic feature, there is provided a financing system comprising: (a) an automated financial transaction machine (AFTM), installed in a nonbank location of a fee recipient entity under a payment-by-results contract with a financial institution, for performing an electronic financial transaction upon a customer's request; (b) a history information obtaining unit for obtaining electronic history information of the AFTM; and (c) an AFTM placement fee determination unit, operatively connected with the history information obtaining unit, for determining an AFTM placement fee, which is to be paid to the fee recipient entity, in a computer-implemented way based on the electronic history information obtained in the history information obtaining unit.

To attain the above-mentioned fourth object, as the fifth generic feature, there is provided an automated transaction machine (ATM), which is to be installed in a nonbank location of a fee recipient entity under a payment-by-results contract with a service provider, for providing services to customers upon their requests in a computer-implemented way, comprising: (a) a history information obtaining unit for obtaining electronic history information of the ATM; and (b) an ATM placement fee determining unit, operatively connected with the history information obtaining unit, for determining the ATM placement fee, which is to be paid to the fee recipient entity, in a computer-implemented way based on the electronic history information obtained by the history information obtaining unit.

As a sixth generic feature, there is provided an automated financial transaction machine (AFTM), which is to be installed in a nonbank location of a fee recipient entity under a payment-by-results contract with a financial institution, for performing a financial transaction upon a customer's request in a computer-implemented way, comprising: (a) a history information obtaining unit for obtaining electronic history information of the AFTM; and (b) an AFTM placement fee determining unit, operatively connected with the history information obtaining unit, for determining the AFTM placement fee, which is to be paid to the fee recipient entity, in a computer-implemented way based on the electronic history information obtained by the history information obtaining unit.

According to the above-mentioned method, systems and machines, an ATM (AFTM) placement fee to be paid to a fee recipient entity in a nonbank location is determined based on the electronic history information of the ATM (AFTM).

With foregoing features of the placement fee determination method, the service providing system, the financing system, the ATM and the AFTM, it is possible to guarantee the following advantageous results:

(1) Since an ATM placement fee is determined based on electronic history information (a transaction history, a maintenance history), which has been obtained, it is possible to fairly determine placement fees for each of ATMs in accordance with the electronic history information. Further, it is possible for a service provider to effectively pay respective placement fees by eliminating possibility of payment of unreasonable placement fees.

(2) The determination of an ATM placement fee based on the length of time during which the ATM has been kept in proper condition for service encourages the fee recipient entity in enthusiastically performing a maintenance operation and contacting with the service provider and the working agent as a problem arises. Therefore, it is possible for an individual ATM to be in a proper condition for service for an extended length of time so that more transactions can be performed on the individual ATM by customers. As an advantage of the service provider, it is possible to reduce costs for operating the respective ATMs.

(3) Determination of an ATM placement fee based on the browsing history about browsing web contents, especially web contents beneficial to the service provider, can improve the convenience of the service provider.

(4) Because the determination of an ATM placement fee based on the maintenance history encourages the fee recipient entity in enthusiastically performing maintenance operations, it is possible for the ATM to keep in a proper condition for service for an extended length of time so that more transactions can be also performed on the ATM. As an advantage of the service provider, it is possible to reduce the costs for working the respective ATMs.

(5) Because the determination of an ATM placement fee based on the item loading history encourages the fee recipient entity in enthusiastically loading the ATM with consumption items, it is possible for the ATM to keep in a proper condition for service for an extended length of time so that an increased number of transactions can be also performed on the ATM. As an advantage of the service provider, it is possible to reduce operations by the service provider to work the ATM in good condition.

(6) Since an ATM placement fee determined based on the problem solving history with respect to the ATM encourages the fee recipient entity in further enthusiastically solving problems arose with respect to the ATM, it is also possible for the ATM to keep in a proper condition for service for an extended length of time so that more transactions can be also performed on the ATM. Additionally, it is also possible for the service provider to reduce costs for working the ATMs.

(7) Since the determination of an ATM placement fee based on the money loading history, which is defined in terms of the total number of bills loaded, the total sum of the money loaded or the like, encourages the fee recipient entity in enthusiastically loading the ATM with money, it is also possible for the ATM to keep in a proper condition for service for an extended length of time so that an increased number of transactions can be performed on the ATM. Additionally, it is also possible for the service provider to reduce the costs for working the ATMs.

Other objects and further features of the present invention will be apparent from the following detailed description when read in conjunction with the accompanying drawings.

### BRIEF DESCRIPTION OF THE DRAWINGS

FIG. 1 is a block diagram schematically showing an automated teller system according to a first embodiment of the present invention;

FIG. 2 is a block diagram schematically showing hardware of an automated teller machine of the automated teller system of FIG. 1;

FIG. 3 is a block diagram schematically showing software of the automated teller machine of FIG. 2;

FIG. 4 is a flow diagram illustrating a succession of procedural steps performed by the automated teller machine of FIG. 2;

FIG. 5 is a block diagram schematically showing an automated teller system according to a second embodiment;

FIG. 6 is a block diagram schematically showing hardware of an automated teller machine of the automated teller system of FIG. 5;

FIG. 7 is a block diagram schematically showing software of the automated teller machine of FIG. 4;

FIG. 8 is a block diagram schematically showing hardware of an information management server of the automated teller system of FIG. 5;

FIG. 9 is a block diagram schematically showing software of the information management server of FIG. 8;

FIG. 10 is a block diagram schematically showing an automated teller system according to a third embodiment;

FIG. 11 is a block diagram schematically showing software of the automated teller machine of the automated teller system of FIG. 10;

FIG. 12 is a block diagram schematically showing hardware of an information management server of the automated teller system of FIG. 10;

FIG. 13 is a block diagram schematically showing software of the information management server of FIG. 12;

FIG. 14 is a flow diagram illustrating a succession of procedural steps performed in the automatic teller system of FIG. 10;

FIG. 15 is a flow diagram illustrating a succession of procedural steps performed by the information management server of FIG. 12 serving as a proxy server; and

FIG. 16 is a block diagram schematically showing an automated teller system according to a modification of the present invention.

### DESCRIPTION OF THE PREFERRED EMBODIMENTS

Various preferred embodiments of the present invention will now be described with reference to the accompanying drawings.

(A) First Embodiment:

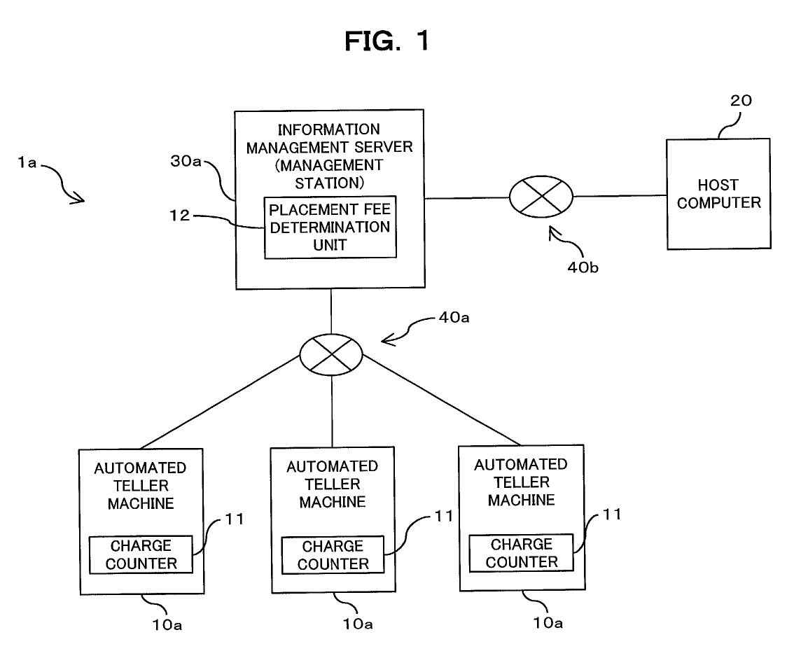

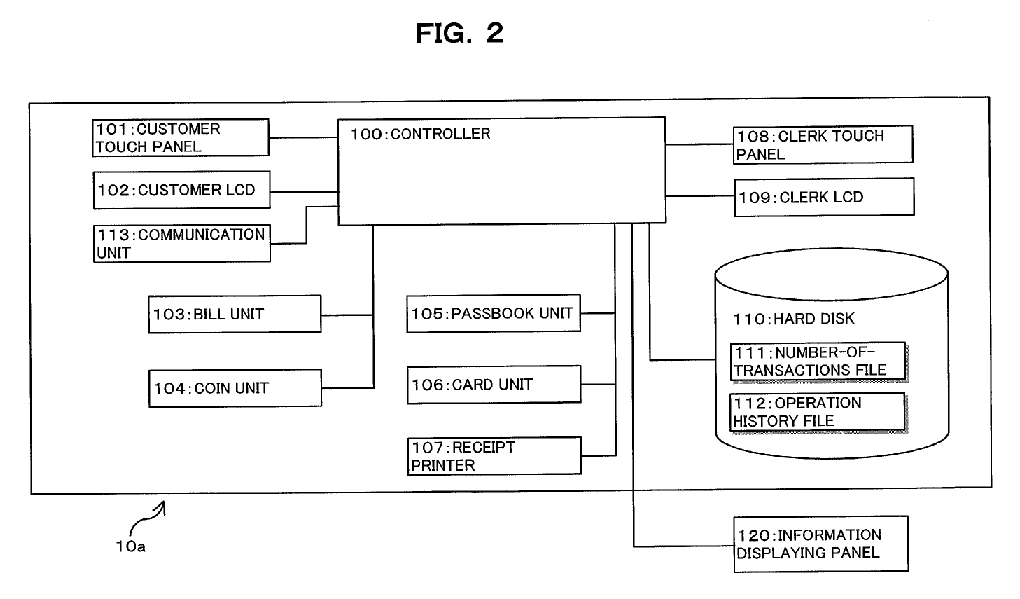

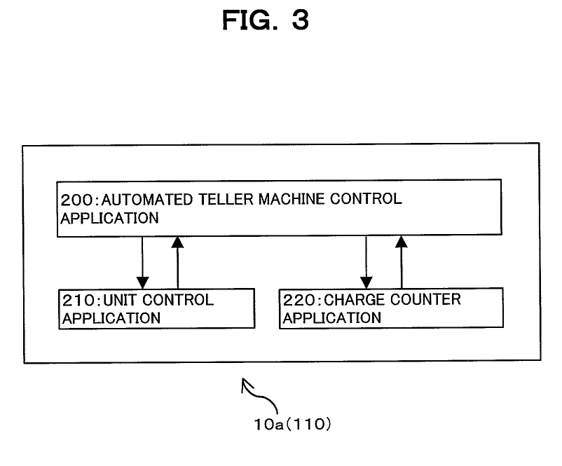

FIG. 1 shows an automated teller system according to a first embodiment, and FIGS. 2 and 3 show hardware and software of the automated teller system of FIG. 1, respectively.

As shown in FIG. 1, the automated teller system 1a of the first embodiment comprises at least one automated teller machine (automated transaction machine (ATM), automated financial transaction machine (AFTM)) 10a, a host computer 20, an information management server (a management station) 30a, and networks 40a and 40b.

Each automated teller machine 10a is installed in a retail store or the like (a fee recipient entity) and is an automated transaction machine (ATM) (an automated financial transaction machine (AFTM)) that is managed by a financial institution under a payment-by-result contract between the fee recipient entity and the financial institution (service provider). Under management of the financial institution, the automated teller machine 10a dispenses cash to individual customers, and records a credit, of the same amount as an amount of cash that a customer deposits into the automated teller machine 10a, to an account designated by the customer, on their request. In the automated teller system 1a are a plurality of the automatic teller machines 10a connected to the information management server 30a via the network 40a.

Here, hardware of the automated teller machine 10a will be now described with reference to FIG. 2. The individual automated teller machine 10a comprises a controller 100, a customer touch panel 101, a customer liquid crystal display (LCD) 102, a bill unit 103, a coin unit 104, a passbook unit 105, a card unit 106, a receipt printer 107, a clerk touch panel 108, a clerk LCD 109, a hard disk 110, a communication unit 113 and an information display panel 120.

The controller 100 controls overall each element of the automated teller machine 10a, each of which elements are the customer touch panel 101, the customer liquid crystal display (LCD) 102, the bill unit 103, the coin unit 104, the passbook unit 105, the card unit 106, the receipt printer 107, the clerk touch panel 108, the clerk LCD 109, the hard disk 110, the communication unit 113 and the information display panel 120.

The controller 100 is realized by a central processing unit (CPU) of a computer or the like executing programs stored in the hard disk 110. Execution of such programs allows the controller 100 to serve also as a later-described charge counter 11.

The customer LCD 102 displays various information items for customers. From the customer touch panel 101 inputs an individual customer information. Namely, individual customers input information from the customer touch panel 101 in response to information and directions displayed on the customer LCD 102.

The bill unit 103 dispenses, counts, and stores bills (banknotes) in the automated teller machine 10a and includes a bill receiving slot, a bill dispensing slot, a bill transferring section, a bill counting section and a bill storing section, which do not appear in the accompanying drawings. In the bill unit 103, the bill transferring section transfers bills that have been deposited into the automated teller machine 1a from the bill receiving slot to the bill counting section, which counts the deposited bills, and then further transfers the bills to the bill storing section to be stored therein. Conversely, the bill transferring section transfers bills stored in the bill storing section to the bill counting section that counts the stored bills and further transfers the bills to the bill dispensing slot in the bill unit 103.

The bill dispensing slot and the bill receiving slot may be formed by a shared slot and their various modifications can be suggested without departing from the concept of the present invention.

The bill unit 103 also includes an optical sensor, thereby detecting the number of bills stored in the bill storing section.

The coin unit 104 dispenses, counts and stores coins in the automated teller machine 10a and includes a coin receiving slot, a coin dispensing slot, a coin transferring section, a coin counting section and a coin storing section, which do not appear in the accompanying drawings. In the coin unit 104, coins deposited into the automated teller machine 10a from the coin receiving slot are transferred to the coin counting section, which counts the deposited coins, by the coin transferring section, and then the counted coins are further transferred to the coin storing section to be stored therein. Conversely, the coin transferring section transfers coins stored in the coin storing section to the coin counting section that counts the stored coins and further transfers the coins to the coin dispensing slot in the coin unit 104.

The coin dispensing slot and the coin receiving slot may be formed by a shared slot, and their various modifications can be suggested without departing from the concept of the present invention.

The coin unit 104 also includes an optical sensor or a weight sensor, thereby detecting the number of coins stored in the coin storing section.

The passbook unit 105 prints records of transactions onto a passbook of an individual customer and includes a non-illustrated printhead. The passbook unit 105 prints a history record of transactions onto a passbook inserted into the automated teller machine 10a by a customer. A customer inserts a medium (e.g., a magnetic card, an IC card; hereinafter simply called a “card”) capable of identifying an individual customer and his/her account with a financial institution into the card unit 106. The card unit 106 reads contents registered in inserted cards.

The receipt unit 107 includes a non-illustrated printhead and prints contents of an individual transaction onto a receipt that is to be issued to a customer. The receipt unit 107 also has a function for detecting the amount of receipt paper remaining.

The clerk LCD 109 displays various information items for managers and clerks at a retail store where the automated teller machine 10a is installed, and is in the form of a LCD. From the clerk touch panel 108 mangers and clerks input information. The managers and the clerks at the retail store input information from the clerk touch panel 108 in response to information and directions displayed on the clerk LCD 109.

The hard disk 110 stores an OS (operating system) that causes the automated teller machine 10a to function, programs described in detail later with reference to FIG. 3, and electronic history information (a transaction history and a maintenance history) of the automated teller machine 10a. The electronic information is used to determine a placement fee for the automated teller machine a. In practice, the electronic history information takes the form of a number-of-transactions file 111 and an operation history file 112 held in the hard disk 110.

The number-of-transactions file 111 records the number of transactions performed on the individual automated teller machine 10a. The operation history file 112 retains various history information pieces about transactions that have been performed on the automated teller machine 10a. The history information in the operation history file 112 contains the total sum (the transaction history) of money that has been transacted on the automated teller machine 10a during the individual transactions, the total length of time during which the automated teller machine 10a has been kept in proper condition for service, a money loading history (a maintenance history), an item loading history (a maintenance history), and a problem solving history (e.g., details and the time of solving problems by the fee recipient entity; a maintenance history). Maintenance operations whose contents are stored in the operation history file 112 are performed by clerks and managers (a fee recipient entity) of a retail store in which the automated teller machine 10a is installed.

The electronic history information retained in the number-of-transactions file 111 and the operation history file 112 is used by the placement fee determination unit 12 in the information management server 30a to determine a placement fee of the automated teller machine 10a. The manner of determination of a placement fee will be described in detail later.

The information display panel 120 displays information about the automated teller machine 10a and is installed in the same place as the clerks e.g., near to registers remote from the automated teller machine 10a. The information displayed on the information panel 120 notifies the manager and the clerks at a retail store of the absence or shortage of bills, coins, and consumption items.

The communication unit 113 communicates with the information management server 30a via the network 40a and is in the form of a local area network (LAN) card or the like. The communication unit 113 is provoked by the automated teller machine 10a to communicate with the information management server 30a and the host computer 20 via the networks 40a and 40b thereby performing various transactions and sending/receiving information.

As shown in FIG. 1, the automated teller machine 10a also has a charge counter (a history information obtaining unit) 11 that obtains information for determination of a placement fee to be paid to the retail store (the fee recipient entity) by a financial institution. The charge counter 11 obtains electronic history information of the automated teller machine 10a to reproduce information used for the determination of a placement fee to be paid to the fee recipient entity. Specifically, the charge counter 11 writes (updates) the electronic history information in the number-of-transactions file 111 and the operation history file 112.

The charge counter 11 obtains, as the electronic history information, the total sum of money that has been transacted on the automated teller machine 10a, the total length of time during which the automated teller machine 10a has been kept in proper condition for service, money loading history (the total number of loaded bills, the total sum of the loaded money), item loading history, and problem solving history of individual components performed over a predetermined time period. The loading of the automated teller machine 10a with money or consumption items and a problem solving are performed by the manager and the clerks at a retail store (the fee recipient entity).

The automated teller machine 10a is in proper condition for service as long as no problems, such as lack of money or consumption items in the automated teller machine 10a arise.

The money loading history includes information about the time when the automated teller machine 10a came to a halt due to the absence or lack of money therein, the time when the automated teller machine 10a restarted service, and the total sum of money or the total number of bills (banknotes) loaded by the manager or the clerks of the retail store, in which the automated teller machine 10a is installed.

The item loading history includes information about the time when the automated teller machine 10a came to a halt due to absence of ink for printing in the receipt unit 107 or in the passbook unit 105 and paper for receipt, the time when the automated teller machine 10a restarted service, and the name of an item which has been loaded into the automated teller machine 10a, the number of times that the manager and the clerks have loaded the automated teller machine 10a with consumption items, or other operations performed by the manager or the clerks.

The problem solving history is information about solving problems, which arose with respect to the individual automated teller machine 10a , solved by the manager or the clerks. For example, if there arises a problem in transferring a bill, a coin or a receipt, in the problem solving history is recorded information about the time the problem arose, and the time the manager and the clerks attempted to solve the problem or contact the financial institution or working agent that performs maintenance operations on the automated teller machines 10a under contract with the financial institution.

Software of the automated teller machine 10a will now be described with reference to FIG. 3. The hard disk 110 (FIG. 2) of the automated teller machine 10a is installed in an automated teller machine control application 200, a unit control application 210, and a charge counter application 220.

The automated teller machine control application 200, corresponding to an OS for a computer system, controls various functions and transactions performed on the automated teller machine 10a.

The automated teller machine control application 200 is software that controls transactions performed on the automated teller machine 10a so as to have overall control of input from the customer touch panel 101, display of the customer LCD 102, input from the clerk touch panel 108, display of the clerk LCD 109 and communication of the communication unit 113. The automated teller machine control application 200 requests the unit control application 210 to control respective units in the automated teller machine 10a, and the charge counter application 220 to control input and output of the number-of-transactions file 111 and the operation history file 112.

The unit control application 210 respectively controls the bill unit 103, the coin unit 104, the passbook unit 105, the card unit 106, the receipt printer 107, the communication unit 113 and the information display panel 120 on the basis of requests from the automated teller machine control application 200.

The automated teller machine 10a is realized by the CPU in a computer or the like executing the automatic teller machine control application 200 and the unit control application 210.

The charge counter application 220 is a program executed by the CPU (not illustrated) to function as the charge counter 11.

The host computer 20, which is managed by a financial institution or the like, manages accounts of individual customers of the financial institution (that is, manages customers' deposits at the financial institution) and records of credits and debits to the accounts. The host computer 20 is communicably connected to the information management server 30a via the network 40b and is further communicably connected to each of the automated teller machines 10a via the information management server 30a and the network 40a.

The information management server (the management station) 30a manages transactions performed on the individual automated teller machine 10a and is in the form of a server computer or the like. The information management server 30a determines a placement fee for an individual automated teller machine 10a to be paid to the fee recipient entity, in which the individual automated teller machine 10a is installed, based on the electronic history information with respect to the individual automated teller machine 10a obtained by the charge counter 11.

The information management server 30a includes the placement fee determination unit 12 that determines a placement fee of an individual automated teller machine 10a. The placement fee determination unit 12 determines the placement fee to be paid to the fee recipient entity in a nonbank location in which the automated teller machine 10a is installed based on the electronic history information with respect to the individual automated teller machine 10a obtained by the charge counter 11. The placement fee determination unit 12 is realized by a non-illustrated CPU in the information management server 30a executing a program stored in a non-illustrated storage (e.g., a hard disk).

The placement fee determination unit 12 periodically examines the electronic history information (the transaction history, the maintenance history) recorded in the number-of-transactions file 111 and the operation history file 112 as, for example, the end of each workday or a monthly accounting check in order to determine the placement fee based on the history information.

For example, the placement fee determination unit 12 determines a placement fee based on the number of transactions performed on the individual automated teller machine 10a, which number is recorded in the number-of-transaction file 111. Generally, a higher placement fee is determined for an automated teller machine 10a on which the greater number of transactions are performed; and a lower placement fee is determined for an automated teller machine 10a on which a lesser number of transactions are performed.

The placement fee determination unit 12 determines a placement fee based on the information about the total sum of money that has been transacted on the automated teller machine 10a, the total length of time during which the automated teller machine has been kept in proper condition for service, the loading history of money (the number of loaded bills and the total sum of the loaded money), the item loading history, and a problem solving history with respect to the automated teller machine 10a, which information is recorded in the operation history file 112.

For example, the placement fee determination unit 12 sets a higher placement fee for an automated teller machine 10a on which the greater total sum of money has been transacted and sets a lower placement fee for an automated teller machine 10a on which a smaller total sum of money has been transacted. Further, the longer the length of time during which an automated teller machine 10 has been kept in-service, the higher the placement fee set by the placement fee determination unit 12. On the other hand, the placement fee determination unit 12 sets a lower placement fee for an automated teller machine 10a that has been kept in proper condition for service for a shorter length of time.

The placement fee determination unit 12 determines a higher placement fee for an automated teller machine 10a that has been loaded with a greater number of bills or a greater total sum of money. As a result, a lower placement fee is set for an automated teller machine 10a loaded with a smaller number of bills or smaller total sum of money.

The placement fee determination unit 12 may determine a placement fee for an individual automated teller machine 10a in accordance with the kind of bills that have been loaded into the individual automated teller machine 10a, if the placement fee is defined in terms of the money loading history. For example, a higher placement fee can be set for an automated teller machine mainly loaded with 10,000-yen-bills than that set for an automated teller machine mainly loaded with 1,000-yen-bills.

The placement fee determination unit 12 determines a higher placement fee for an automated teller machine 10a into which consumption items (e.g., receipt paper) have been loaded on a greater number of times, and a lower placement fee for an automated teller machine 10a into which such consumption items have been loaded on a lesser number of times.

Further, the placement fee determination unit 12 determines a placement fee for an automated teller machine 10a according to the number of times that the fee recipient entity has solved a problem of the automated teller machine 10a, such a fee rising in accordance with the number of times problems are solved.

The placement fee determination unit 12 may be equipped with a matrix including placement fees associated with the total number of transactions, the total sum of money transacted, the total length of time during which an automated teller machine 10a has been kept in proper condition for service, the number of bills (banknotes) loaded, the total sum of money loaded, the number of times that a consumption item has been loaded into the automated teller machine 10a, and the number of times that a problem has been solved. The placement fee determination unit 12 may determine a placement fee by referring to this matrix. As an alternative, the placement fee may be equipped with a matrix having discount rates (additional rates) associated with the total number of transactions, the total number of money transacted, the total length of time during which an automated teller machine 10a has been kept in proper condition for service, the number of bills (banknotes) loaded, the total sum of money loaded, the number of times that a consumption item has been loaded into the automated teller machine 10a, and the number of times that problems have been solved. In this case, the placement fee determination unit 12 may determine the placement fee for an individual automated teller machine 10a by multiplying a discount rate (an additional rate) that is obtained by referring to this matrix and a standard placement fee, which has been previously set.

The placement fee determination unit 12 may determine a placement fee based on information other than that described above or based on a part of the above-mentioned electronic history information.

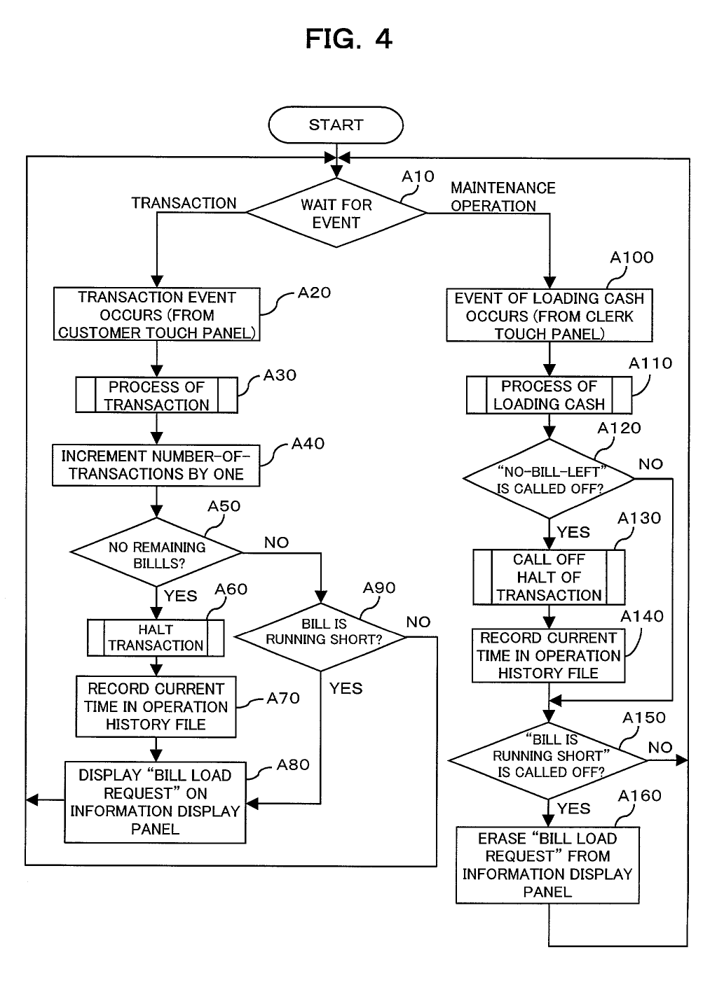

A succession of procedural steps (for obtaining electronic history information) performed by an individual automated teller machine 10a in the automated teller system la will now be described with reference to a flow diagram FIG. 4 (Steps A10 through A160). Here, the automated teller machine 10a is assumed to deal with bills only for convenience.

A customer inputs (selects) a transaction (withdrawing money) from the customer touch panel 101 (“transaction” route in Step A10) after the automated teller machine 10a has been waiting for a transaction by a customer or a maintenance operation by a manager or a clerk (Step A10). The automated teller machine 10a determines that a transaction event has been arisen by a customer (Step A20), and starts a process for the transaction that has been requested by the customer (Step A30).

For example, if the customer wishes to withdraw money from the customer's account or the like, the automated teller machine 10a displays instructions to the customer on the customer LCD 102 in order to ask the customer to insert a customer card and to input a personal identification number (PIN). Following the instruction, the customer inserts a customer card into a non-illustrated card slot, and inputs necessary information, such as a PIN or an amount of money to be withdrawn.

Information (e.g., an account number) read from the customer card and information (e.g., the PIN) input by the customer via the customer touch panel 101 are passed to the automated teller machine control application 200 (the controller 100), which transmits the information to the host computer 20 via the networks 40a and 40b, and checks the information management server 30a. Responding to the received information, the computer 20 verifies PINs and the balance of an account to which a debit is to be recorded.

After verification and checking by the host computer 20, the automated teller machine control application 200 issues an order to the unit control application 210 (the controller 100) to make the bill unit 103 dispense bills of an amount that the customer has requested to withdraw and to make the card unit 106 eject the customer card.

At the time of completion of the transaction (withdrawing bills by the customer), the automated teller machine control application 200 notifies the charge counter application 220 (the charge counter 11) of completion of the transaction (withdrawing bills from the customer). Receipt of the notification causes the charge counter application 220 to update the number-of-transactions file 111 stored in the hard disk 110 thereby incrementing the number of transactions by one (Step A40).

Alternatively, the update of the number-of-transactions file 111 may be done by the charge counter application 220 before completion of the transaction at the Step A30, and other alternatives may be suggested without departing from the concept of the present invention.

After that, the automated teller machine 10a detects the number of bills remaining in the bill storing section of the bill unit 103 in order to check whether or not any bills are left in the bill storing section (Step A50). When no remaining bills are detected (Yes route in Step A50), the automated teller machine control application 200 stops the automated teller machine 10a from making transactions (Step A60).

While the automated teller machine 10a is suspended from making transactions, the customer LCD 102 displays a notice saying that the automated teller machine 10a is out of service, the customer touch panel 101 temporarily accepts no input from customers, or the bill receiving slot in the bill unit 103 and the coin receiving slot in the coin unit 104 close.

The automated teller machine control application 200 records the current time when the transactions halted in the operation history file 112 using the automated teller machine 10a and the charge counter application 220 (Step A70). Then the automated teller machine control application 200 causes the unit control application 210 to display, on the information display panel 120, a notice that requests loading of the automated teller machine 10a with supplemental bills (Step A80), and the procedural steps return to Step A10.

When it is detected that one or more bills remain in the bill storing section (No route in Step A50), the automated teller machine 10a further checks whether or not bills in the bill storing section are running short (i.e., whether or not bills remaining are equal to or less than a predetermined number; Step A90). The manner of detecting the number of bills stored in the bill storing section can be applied by any method known in the art.

When it is detected that bills are not running short in the automated teller machine 10a (No route in Step A90), the procedural steps return to Step A10. On the other hand, when it is detected that the bills are running short, the procedural steps proceed to Step A80.

When the manger or a clerk is aware that no bills are remaining or bills are running short in the bill storing section by referring to information on the information display panel 120, the manager or a clerk inputs information via a clerk touch panel 108 to perform a maintenance operation (loading bills) (“maintenance” route in Step A10). At that time, the automated teller machine 10a determines that a transaction event (a bill loading event) has been arisen by from the manager or a clerk (Step A100).

The manager or the clerk deposits bills into the automated teller machine 10a to record a credit to an account of the retail store in the financial institution, thereby loading the automated teller machine 10a with the bills (Step A110). In this embodiment, the loading of the automated teller machine 10a with bills is executed by recording a credit, of the same amount as the amount of bills deposited into the automated teller machine 10a, to the retail store's account. The loading of bills (money) should by no means be limited to the manner described in this example, and other methods may be applied.

The bills (money) loaded by the manager or the clerk are transferred to the bill counting section to be counted, and then to the bill storing section by the bill transferring section in the bill unit 103.

The automated teller machine 10a detects the number of bills remaining in the bill storing section of the bill unit 103 in order to check whether or not an adequate number of bills are stored in the bill storing section (i.e., whether or not a “no-bill-left state” has been call off; Step A120). When the no-bill-left state has been call off (Yes route in Step A120), the automated teller machine 10a calls off the transaction halt (Step A130) and records the current time when the automated teller machine 10a returns to a proper condition for transaction (service) (Step A140; a history obtaining step). The automated teller machine 10a checks whether or not the bills stored in the bill storing section are still in short supply (Step A150).

When it is detected that the bills are still running short in the automated teller machine 10a (No route in Step A120), the procedural steps proceed to Step A150.

When it is detected that the automated teller machine 10a is loaded with an adequate number of bills (Yes route in Step A150), the notice that requesting loading supplemental bills is erased from the information display panel 120 (Step A160), and the procedural steps return to Step A10. When it is detected that bills in the automated teller machine 10a are still running short (No route in Step A150), the procedural steps return to Step A10 directly.

The placement fee determination unit 12 of the information management server 30a determines a placement fee for the automated teller machine 10a to be paid to the fee recipient entity in a nonbank location in which the automated teller machine 10a is installed based on the electronic history information recorded in the number-of-transactions file 111 and the operation history file 112 (a fee determination step).

Since the placement fee determination unit 12 determines a placement fee for automated teller machine 10a based on the transaction history (the electronic history information) obtained by the charge counter 11 in the automated teller system 1a, it is possible to determine placement fees for individual automated teller machines 10a in accordance with service which the individual automated teller machines 10a have provided with customers thereby paying fair placement fees to the individual fee recipient entities. Further, as an advantage for the financial institution, it is possible to efficiently determine placement fees for the automated teller machines 10a under a payment-by-results contract with fee recipient entities especially by reducing placement fees for some automated teller machine 10a which do not frequently and effectively provide service for customers.

Since the placement fee determination unit 12 also determines placement fees for individual automated teller machines 10a based on the maintenance history (the electronic history information) obtained by the charge counter 11, managers and clerks at fee recipient entities in nonbank locations in which the automated teller machines 10a are installed become keen on maintenance operations with respect to the automated teller machines 10a. It is possible for the financial institution to reduce costs for keeping the automated teller machines 10a be in proper condition for service due to maintenance operations performed by the managers and clerks. As an additional advantage, an increased number of transactions can be performed by the individual automated teller machine 10a because of the extended length of time that the individual automated teller machine 10a is dedicated to providing service to customers.

Since a higher placement fee is determined for an automated teller machine 10a on which a large number of transactions are performed by customers and/or a larger number of maintenance operations by managers and clerks are performed, an increased number of retail stores desire to install automated teller machines 10a in their stores so that the financial institution can easily install the automated teller machines 10a in nonbank locations.

The determination of a placement fee based on the length of time during which an automated teller machine 10a has been kept in proper condition for service encourages the manager and clerks at the retail store, in which the automated teller machine 10a is installed, to enthusiastically maintain contact with the financial institution and the working agent as problems arise. Therefore, it is possible for an individual automated teller machines 10a to be in-service for an extended length of time so that an increased number of transactions can be performed on the individual automated teller machine 10a by customers. It is possible to reduce the cost for working the respective automated teller machines 10a, to the advantage of the financial institution.

Because the determination of a placement fee based on item loading history encourages the managers and the clerks at the retail stores to enthusiastically load the individual automated teller machines 10a with consumption items, it is possible for the individual automated teller machines 10a to stay in a proper condition for service for an extended length of time so that an increased number of transactions can also be performed on the automated teller machines 10a. It is possible to reduce cost for working the respective automated teller machines 10a, to the advantage of the financial institution.

Further, since placement fees determined based on problem solving history with respect to the individual automated teller machines 10a encourages the managers and the clerks at the retail stores to become more enthusiastic about solving problems arising with individual automated teller machines 10a, it is also possible for the individual automated teller machines 10a to stay in a proper condition for service for an extended length of time so that an increased number of transactions can be performed on the automated teller machines 10a. Additionally, it is also possible for the financial institution to reduce costs for working the individual automated teller machines 10a.

Still further, since the determination of a placement fee based on money loading history, which is defined in terms of the total number of loaded bills, the total sum of money loaded or the like, encourages managers and clerks at the retail stores to greater efforts in loading the individual automated teller machines 10a with money, it is also possible for the individual automated teller machines 10a to stay in-service for an extended time so that an increased number of transactions can be performed on the automated teller machines 10a. Additionally, it is also possible for the financial institution to reduce the costs of operating the individual automated teller machines 10a.

(B) Second Embodiment:

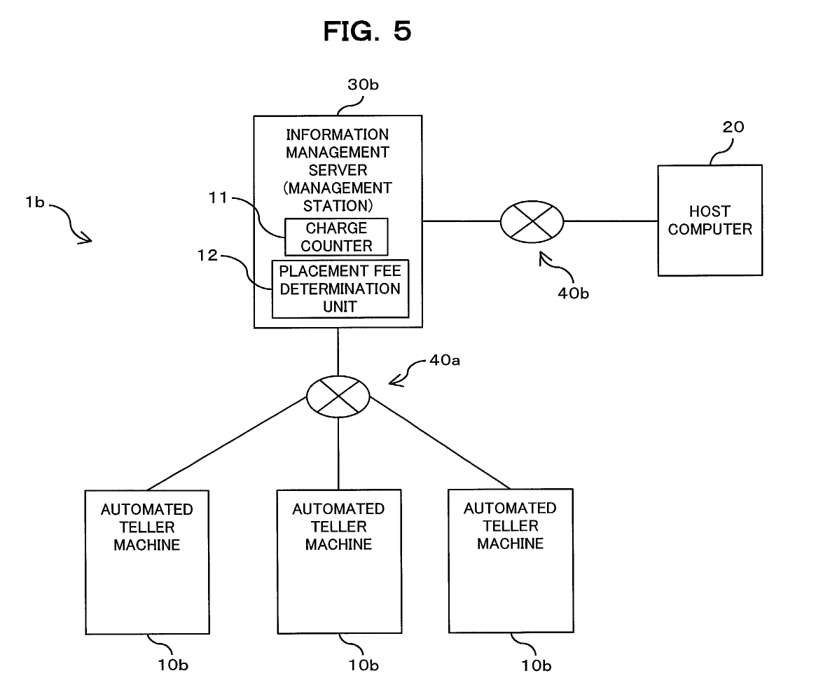

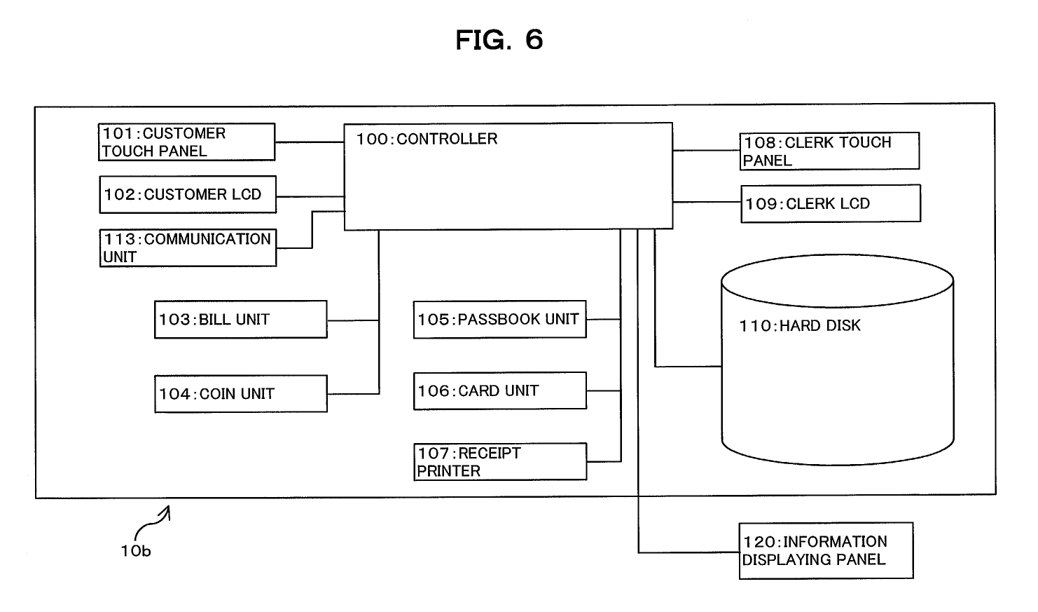

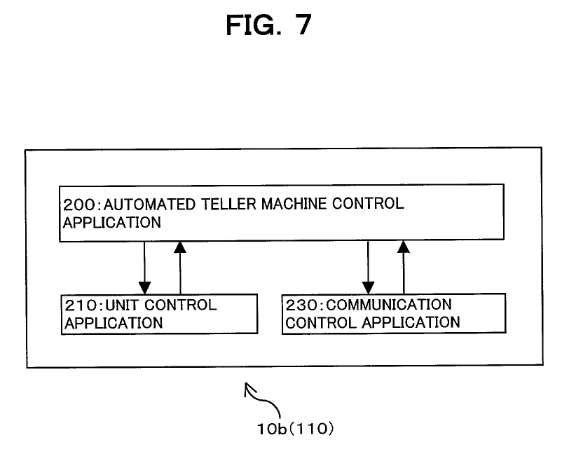

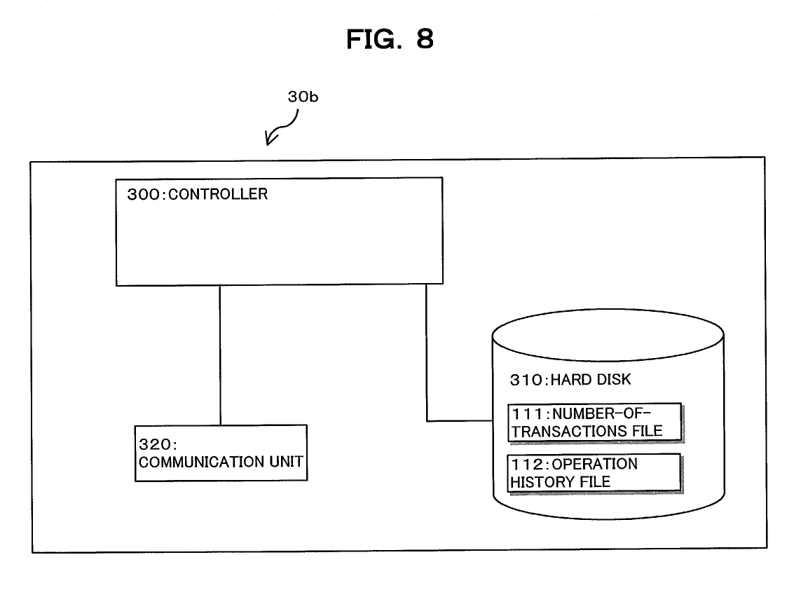

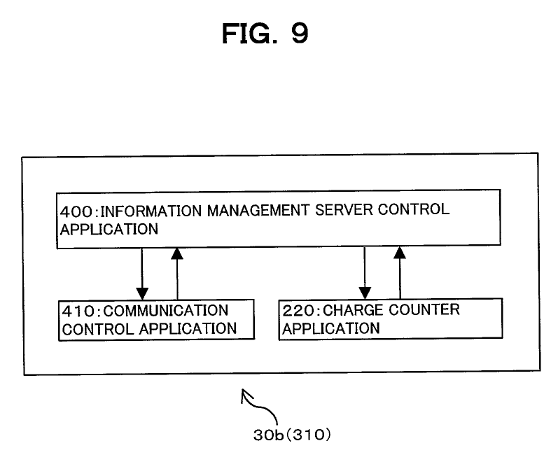

FIG. 5 schematically shows an automated teller system according to a second embodiment; FIGS. 6 and 7 schematically show hardware and software of the automated teller machine, respectively; and FIGS. 8 and 9 schematically show hardware and software of an information management server.

As shown in FIG. 5, an automated teller system 1b according to the second embodiment comprises an information management server 30b and a plurality of automated teller machines 10b as substitutions for the information management server 30a and the automated teller machines 10a of the first embodiment.

In the automated teller machine 1b, the information management server 30b includes a charge counter 11 as shown in FIG. 5 and a hard disk 310 that stores a number-of-transactions file 111 and an operation history file 112 as shown in FIG. 8.

In the automated teller system 1b of the second embodiment, the information management server 30b comprises the charge counter 11, which is included in the automated teller machine 10a in the first embodiment. The charge counter 11 in the information management server 30b obtains various pieces of electronic history information of an individual automated teller machine 10b.

The hard disk 310 in the information management server 30b stores the number-of-transactions file 111 and the operation history file 112 (FIG. 8), however, are stored neither the number-of-transactions file 111 nor the operation history file 112 (FIG. 6) in the hard disk 110 in the individual automated teller machine 10b.

Like reference numbers designate similar parts or elements throughout several views of different illustrated examples, so any repetitious description is omitted here.

The automated teller machine 10b is installed in a nonbank location, such as a retail store, under a payment-by-result contract with a financial institution or the like, likewise the automated teller machine 10a of the first embodiment. The automated teller machine 10b is an automated financial transaction machine (AFTM, an automated transaction machine (ATM)) that dispenses cash to customers and receives cash from customers to record a credit to an account designated by the customers, on the request of the individual customers. The individual automated teller machine 10b is communicably connected to the information management server 30b via the network 40a. The automated teller machine 10b is mainly identical in construction to the automated teller machine 10a; however, in the second embodiment, since the number-of-transactions file 111 and the operation history file 112 are stored in the hard disk 310 of the information management server 30b, the automated teller machine 10b has neither number-of transactions file 111 nor operation history file 112.

Software of the automated teller machine 10b of the automated teller system 10b will now be described with reference to FIG. 7. The hard disk 110 of the automated teller machine 10b stores the automated teller machine control application 200, the unit control application 210, and the communication control application 230. The communication control application 230 substitutes for the charge counter application 220 of the first embodiment.

Software of the communication control application 230 controls the communication unit 113 responsive to individual requests from the automated teller machine control application 200 so as to communicate with the information management server 30b and/or the host computer 20 via networks 40a and 40b.

Upon completion of a transaction or maintenance operation performed on the automated teller machine 10b, the automated teller machine control application 200 requests the communication control application 230 to send electronic history information about the transaction or the maintenance operation to the information management server 30b.

In succession, a configuration and functions of the information management server 30b will be described.

The information management server 30b, similar to the information management server 30a of the first embodiment, manages transactions performed on the individual automated teller machines 30b and is in the form of a server computer or the like. The information management server 30b determines a placement fee of the individual automated teller machine 10b to be paid to a fee recipient entity, e.g., the retail store, by a service provider (the financial institution), which has asked the fee recipient entity to install the automated teller machines 10 based on the electronic history information of the individual automated teller machine 10b obtained by the charge counter 11.

The information management server 30b comprises the charge counter 11 and the placement fee determination unit 12. The charge counter 11 stores electronic history information, which is received from the individual automated teller machines 10b, in the number-of-transactions file 111 and the operation history file 112.

The placement fee determination unit 12 determines placement fees of the individual automated teller machines 10b paid to the responsive fee recipient entities based on the electronic history information (a transaction history and a maintenance history) stored in the number-of-transactions file 111 and the operation history file 112.

A non-illustrated CPU in the information management server 30b executes one or more programs stored in non-illustrated storage (e.g., a hard disk) in order to realize the charge counter 11 and the placement fee determination unit 12.

Hardware of the information management server 30b will now be described with reference to FIG. 8. The information management server 30b comprises a controller 300, the hard disk 310, and a communication unit 320.

The controller 300 controls the information management server 30b and is a CPU or the like. The communication unit 320 allows the information management server 30b to communicate with the individual automated teller machines 10b and the host computer 20 via the networks 40a and 40b and is in the form of a LAN card or the like.

The hard disk 310 is a storage that stores various data and programs (applications), and in this embodiment stores the number-of-transactions file 112 and the operation history file 112.

Software of the information management server 30b will now be described with reference to FIG. 9.

The hard disk 310 (FIG. 8) of information management server 30b stores an information management server control application 400, a communication control application 410, and the charge counter application 220, as shown in FIG. 9.

The information management server application 400, serving to function as an OS (operating system) in a computer system, controls various elements and processes of the information management server 30b. The information management server application 400 requests the communication application 410 to communicate with the automated teller machine 10b and the host computer 20 and requests the charge counter application 220 to control input and output of the electronic history record stored in the number-of-transaction file 111 and the operation history file 112.

The communication control application 410 communicates with the respective automated teller machines 10b and the host computer 20 via the networks 40a and 40b on the request of the information management server control application 400.

The charge counter application 220 is a program that is executed by a non-illustrated CPU to realize the charge counter 11.

In the above-mentioned automated teller system 1b, when a customer operates the automated teller machine 10b to make a transaction, such as a withdrawal of cash, the communication unit 113 sends the information management server 30b information about the transaction made by the customer. Upon receipt of the information, the charge counter 11 of the information management server 30b records contents of the transaction (e.g., the time when the transaction has been performed, the total number of transactions) onto the number-of-transactions file 111 and the operation history file 112.

When a manager or a clerk of a retail store in which the automated teller machine 10b is installed performs a maintenance operation with respect to the automated teller machine 10b, the communication unit 113 sends the information management server 30b information about the maintenance operation to record the information in the number-of-transaction file 111 and the operation history file 112 (a history obtaining step).

Upon receipt of the information, the placement fee determination unit 12 determines a placement fee of the individual automated teller machine 10b to be paid to the fee recipient entity based on the electronic history information stored in the number-of-transactions file 111 and the operation history file 112 (a placement fee determination step).

It is possible for the automated teller system 1b of the second embodiment to guarantee the same advantages as those of the automated teller system 1a.

(C) Third Embodiment:

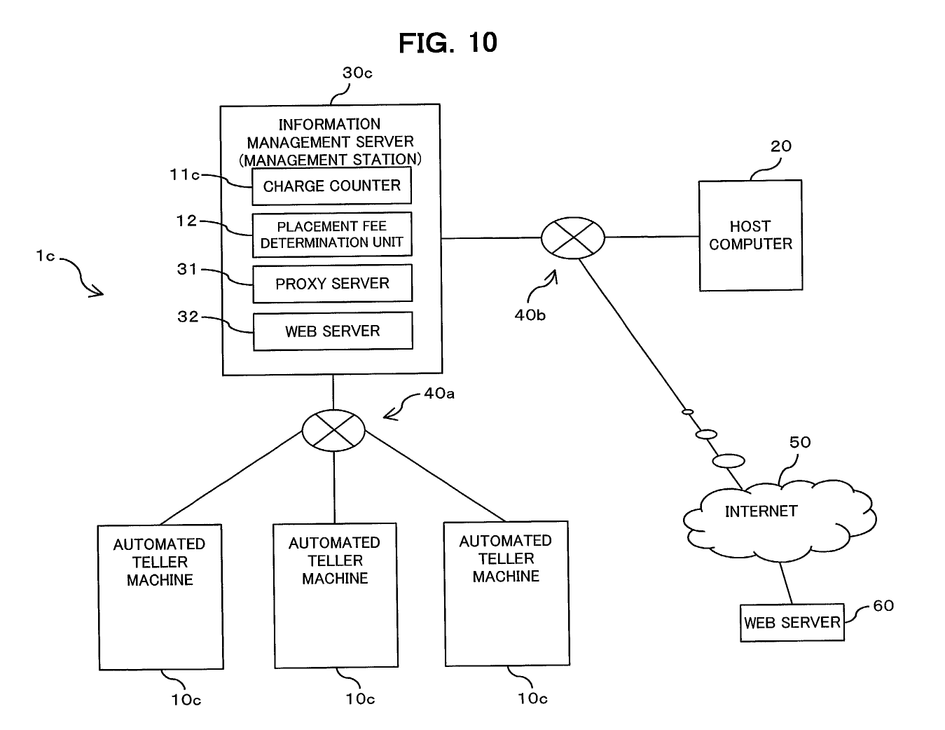

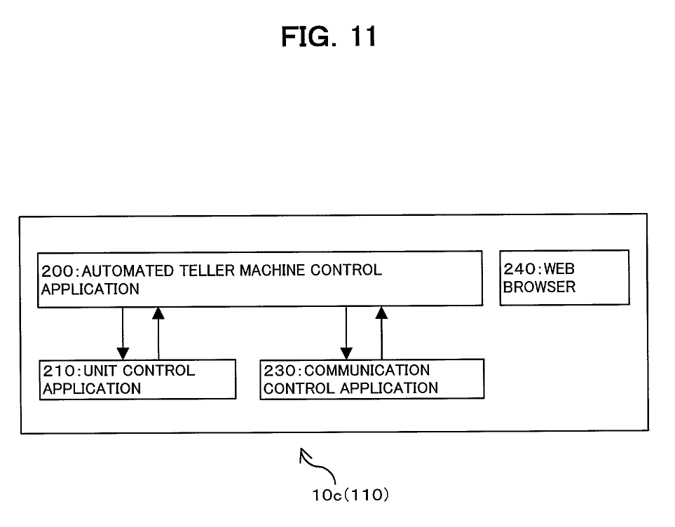

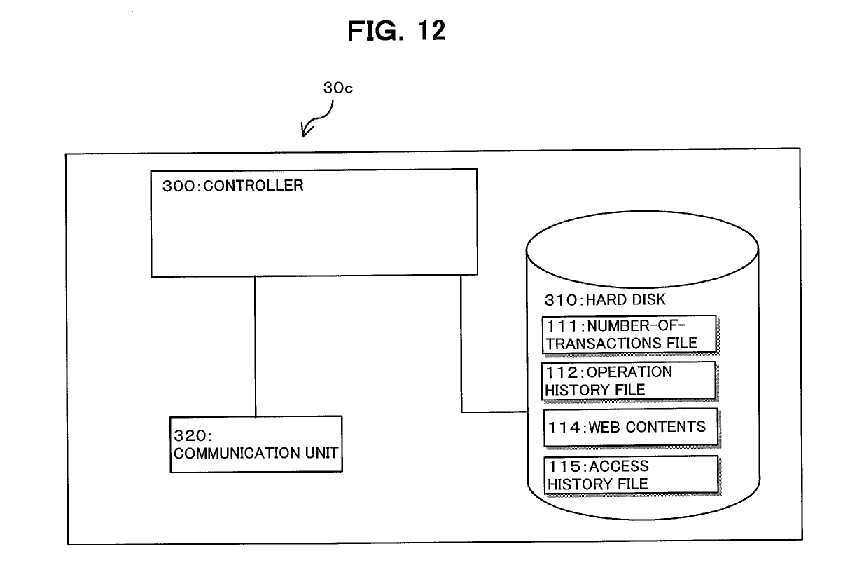

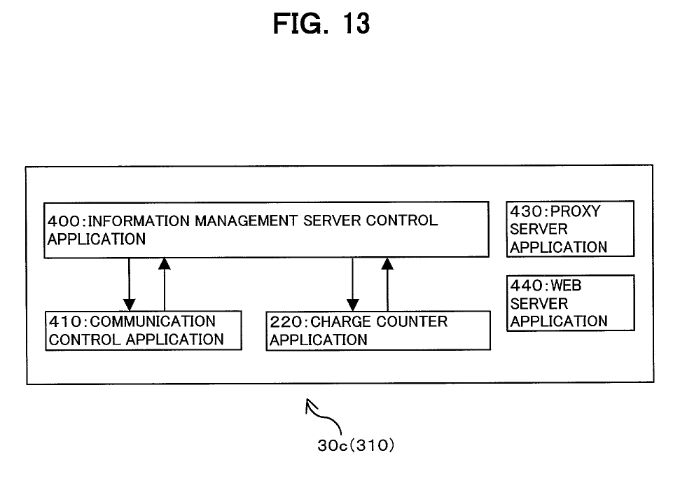

FIG. 10 schematically shows an automated teller system according to a third embodiment; FIG. 11 schematically shows software of an automated teller machine of the automated teller system of FIG. 10; and FIGS. 12 and 13 schematically show hardware and software of an information management server of the automated teller system of FIG. 10, respectively.

As shown in FIG. 10, the automated teller machine 10c of the third embodiment includes an information management server 30c and automated teller machines 10c as substitutions for the information management server 30b and the automated teller machines 10b in the second embodiment, and further includes a web server 60. Like reference numbers designate similar parts or elements throughout several views of different illustrated examples, so any repetitious description is also omitted here.

The web server 60 distributes, on the Internet, web contents to various terminals connected to the Internet and is communicably connected to the networks 40b through the Internet. The individual automated teller machines 10c obtain web contents provided by the web server 60 so that customers may browse the obtained contents.

The individual automated teller machine 10c includes a hard disk 110 that is identical with the hard disk 110 in the automated teller machine 10b of the second embodiment and that includes a web browser 240. The web browser 240, exemplified by Internet Explorer of Microsoft® Corporation, accesses the information management server 30c and the web server 60 sends and receives web contents provided by the information management server 30c or the web server 60 so that the customer can browse the web contents.

The automated teller machine 10c causes the web browser 240 to display web contents on the customer LCD 102 (FIGS. 2 and 6). Customers also display desired web contents on the customer LCD 102 by inputting URL or other information from the customer touch panel 101 (FIGS. 2 and 6). The automated teller machines 10c are identical in hardware configuration to the automated teller machines 10a and 10b, so any repetitious description is omitted here.

The information management server 30c stores an access history file 115 and web contents 114 in the hard disk 310 in addition to the number-of-transactions file 111 and the operation history file 112. The web contents 114 are information items described with HTML (hypertext markup language) and are browsed by use of the web browser 240 installed in the automated teller machine 10c.

The web contents 114 contain information that provides the financial institution, which manages the automated teller machine 10c, with benefits (e.g., increasing the number of customers, reducing the manual labor needed to answer queries from customers) resulting from customers browsing the information. The information may be web contents about the financial institution.

The access history file 115 retains a history of “accesses to web contents that provide benefits to the financial institution (hereinafter called beneficial accesses)”, which accesses have been made from the individual automated teller machine 10c. For example, the charge counter 11c records the time when beneficial accesses are made with the individual automated teller machine 10c and the total number of beneficial accesses that have been performed on the individual automated teller machine 10c.

The placement fee determination unit 12 periodically examines the access history file 115 at the time when the end of workdays, a monthly accounting check or the like in order to determine the placement fee for the individual automated teller machine 10c based on the total number of beneficial accesses to particular web sites browsed using the individual automated teller machine 10c, information on individual accesses being recorded in the access history file 115.

The “beneficial accesses” may be accesses to information having a high possibility of providing benefit to the financial institution (such as maps of branch offices), asking for advertising documents via the web site of the financial institution, or payment for a transaction on a web site with a credit card issued by the financial institution.

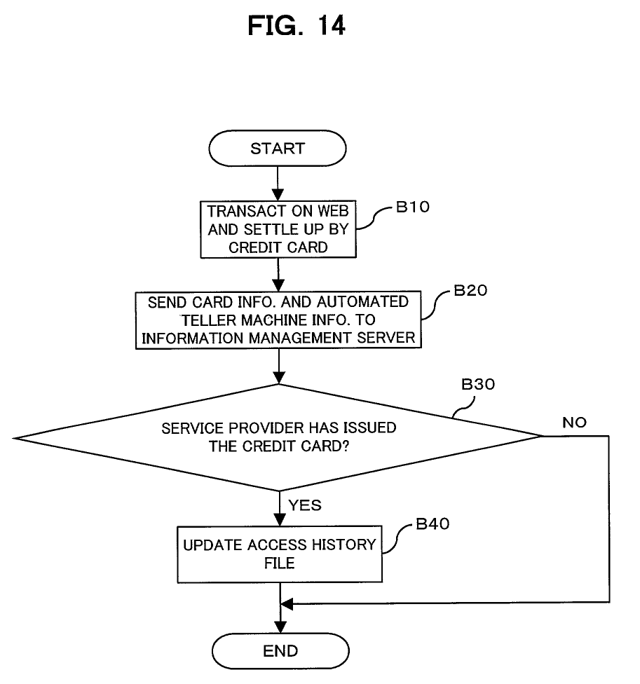

The procedural steps performed in the automatic teller machine 10c when a customer pays for a commodity, service or the like transacted on the Internet with a credit card issued by the identical financial institution will now be described with reference to flow diagram FIG. 14 (Steps B10 through B40).

When a customer accesses the Internet using the automated teller machine 10c to make a transaction on a particular web site, and pays (settles) for the transaction with a credit card (Step B10), the automated teller machine 10c sends the information management server 30c (a proxy server 31 in FIG. 10) information about the credit card along with information about the automated teller machine 10c (Step B20). The information about the credit card includes the name of the financial institution that issued the credit card, the credit card number, PIN and the like. The information about the automated teller machine 10c (hereinafter called the placement information) includes the name of the financial institution that has installed the automated teller machine 10c, and information on the place where the automated teller machine 10c is installed.

Upon receipt of the information, the information management server 30c further sends the credit card information and the automated teller machine 10c received from the automated teller machine 10c to the particular web site, on which the transaction is being performed, to settle on the particular web site. Upon establishment of the transaction, the information management server 30c confirms whether or not the financial institution that issued the credit card is identical with the financial institution (service provider) that installed the automated teller machine 10c (Step B30). If the financial institution that issued the credit card is different from the financial institution that has installed the automated teller machine 10c (No route in Step B30), the information management server 30c completes a succession of the procedural steps.

The establishment of the transaction on the particular web site may be notified to the information management server 30c by a web server of the particular web site by other means.

If the financial institution that issued the credit card is identical to the financial institution that installed the automated teller machine 10c (Yes route in Step B30), the information management server 30c determines that the customer has made a “beneficial access”, and causes the charge counter 11c to update the access history file 115 (Step B40) by adding information (e.g., recording the time when the transaction is made, and incrementing the number of beneficial accesses by one) with respect to the transaction. After that, a succession of the procedural steps is completed.

The “beneficial access” should by no means be limited to accesses to the above-mentioned sites, and may as well be accesses to other sites within the scope of the present inventions.

The information management server 30c also serves as the proxy server 31 and a web server 32. The web server 32 provides the individual automated teller machine 10c with web contents 114. Specifically, responding to the request for an access to the web contents 114 from the automated teller machine 10c, the web server 32 sends the automated teller machine 10c the requested web contents 114.

The proxy server 31 relays accesses performed between the individual automated teller machine 10c and the Internet. Upon receipt of an access request by the information management server 30c from the automated teller machine 10c, the proxy server 31 determines whether the access request is for web data managed by the information management server 30c (whether or not the access is destined for data in the web contents 114), or for web data managed by an external web server 60, and then provides proper web data with the automated teller machine 10c based on the results of the determination.

If an access request from the automated teller machine 10c is destined for web contents 114 in the information management server 30c, the proxy server 31 provides the automated teller machine 10c with the requested web contents 114.

If an access request from the automated teller machine 10c is destined for web contents other than the web contents 114, the proxy server 31 connects the automated teller machine 10c to an external web server that can provide the requested web contents.

Since a customer accesses a web site contained in the web contents 114 using the automated teller machine 10c, the proxy server 31 notifies the charge counter 11c that the access made by the customer is a “beneficial access” for the financial institution.

Upon receipt of the notification, the charge counter 11c records the time when the “beneficial accesses” are made, and the total number of “beneficial accesses” that have been made on the individual automated teller machine 10c in the access history file 115.

Software of the information management server 30c in the automated teller system 1c will now be described with reference to FIG. 13.

The hard disk 310 (FIG. 12) in the information management server 30c includes a proxy server application 430 and a web server application 440 in addition to applications stored in the hard disk 310 in the information management server 30b (i.e., the automated teller machine control application 200, the communication control application 400, and the charge counter application 220), as shown in FIG. 13.

The proxy server application 430 is a program to serve the information management server 30c to function as the proxy server 31 and also functions as a gateway for requests for accesses issued by the automated teller machines 10c. The web server application 440 is a program to serve the information management server 30c to function as the web server 32 and distributes web contents to the individual automated teller machines 10c.

The charge counter 11c has identical functions to the charge counter 11 in the second embodiment. In addition to the foregoing functions, when a customer requests an access to a web site in the web contents 114 using the automated teller machine 10c, the charge counter 11c determines that the customer is making a “beneficial access”. After that, the charge counter 11c updates the access history file 115 by adding the time when the “beneficial access” is made (hereinafter simply called “access time”), and the total number of “beneficial accesses”.

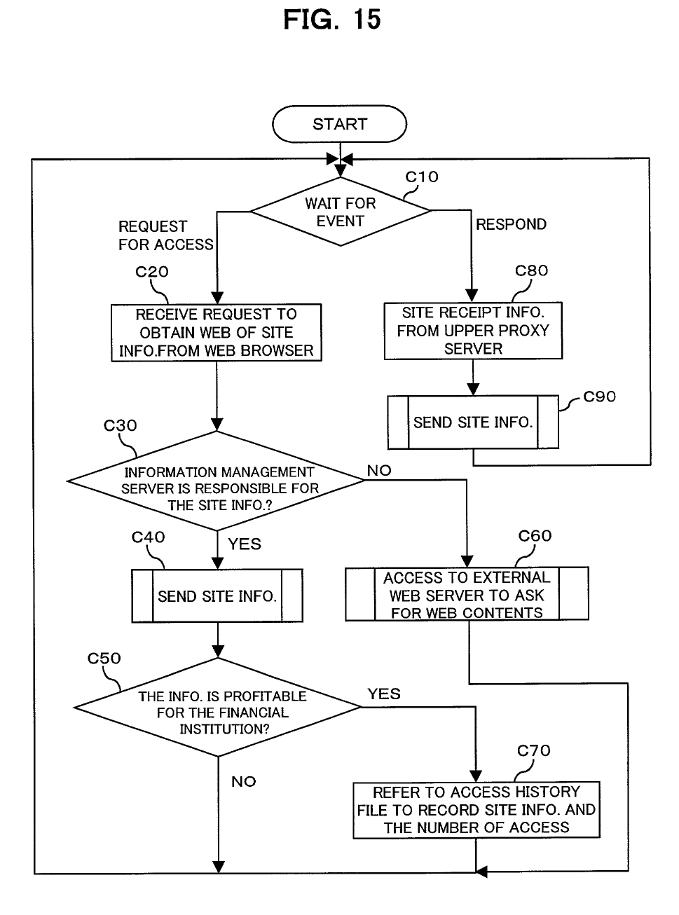

A succession of procedural steps (a history obtaining step) performed by the information management server 30c serving as the proxy server 31 will now be described with reference to flow diagram FIG. 15 (Steps C10 through C90).

First of all, the information management server 30c (the proxy server 31) waits for inputting by a customer from the automated teller machine 10c (Step C10). When a customer requests the web browser 240 of the automated teller machine 10c to obtain (access to) web contents (site information) (“request for an access” route in Step C10), the information management server 10c receives the request (Step C20), and determines whether or not the information management server 10c manages the requested site information (that is, whether or not the requested site information is contained in the web contents 114) (Step C30).

If the requested site information is not contained in the web contents 114 (No route in Step C30), the information management server 30c accesses an external web server 60 that has (manages) the requested site information to obtain the requested site information (Step C60) whereupon the procedural steps return to Step C10.

On the contrary, if the information management server 30c manages the requested site information (Yes route in Step C30), the information management server 30c sends the requested site information to the automated teller machine 30c (Step C40), and determines whether or not the access to the requested site information is a “beneficial access” (Step C50). As mentioned above, “beneficial access” may be that the requested site information is of beneficial to the financial institution or that a customer is asking the financial institution for an advertised document.

If the access to the requested site is a “beneficial access” for the financial institution (Yes route in Step C50), the charge counter 11c updates the access time and the total number of “beneficial accesses” that are made on the individual automated teller machines 10c in the access history file 115 (Step C70). If the access to the requested site is not a “beneficial access” (No route in Step C50), the procedural steps return to Step C10.

Upon receipt of a response that a non-illustrated upper proxy server sends the requested site information (a “respond” route in Step C10), the information management server 30c receives the requested site information (Step C80), and sends the requested site information to the automated teller machine 10c that issued the request for the access (Step C90) whereupon the procedural steps return to Step C10.

The placement fee determination unit 12 determines a placement fee for the individual automated teller machine 10c to be paid to the fee recipient entity, i.e., the retail store where the automated teller machine 10c is installed, based on the electronic history information with respect to the individual automated teller machine 10c, which information is recorded in the number-of-transactions file 111, the operation history file 112, and the access history file 115 (a placement fee determination step).

As mentioned above, when a customer operates the automated teller machine 10c to make a “beneficial access” to the financial institution, the charge counter 11c records information about the beneficial access (such as the total number of “beneficial accesses” that have been made during a predetermined time period) in the access history file 115 and the placement fee determination unit 12 determines a placement fee of the individual automated teller machine 10c to be paid to the fee recipient entity in a nonbank location in which the automated teller machine 10c is installed based on the access history file 115. Since the placement fee for the individual automated teller machine 10c is determined based on a browsing history of web contents browsed that are beneficial to the financial institution, it is possible to improve the convenience of the financial institution and determine fair placement fees in accordance with contributions of the respective automated teller machines 10c to the financial institution.

(D) Others:

The management station, the charge counters (the history information obtaining unit) 11 and 11c, and the placement fee determination unit 12 are realized by execution of a program stored in a computer-readable medium by CPU in the information management server 30a, 30b or 30c and/or the automated teller machine 10a , 10b or 10c. The computer-readable medium is exemplified by a memory, a magnetic storage, a floppy disk, a memory card, a magneto-optical storage, a CD-ROM, a CD-R, a CD-RW, a DVD, a DVD-R, or a DVD-RW.

The present invention should by no means be limited to these foregoing embodiments, and various changes or modifications may be suggested without departing from the gist of the invention.

For example, the hardware of the automated teller machines 10a , 10b, and 10c should by no means be limited to those described in the first through three embodiments. The automated teller machines 10a , 10b and 10c have LCDs for the customer touch panels 101. As an alternative, a device used as customers input information to the automated teller machines may be realized by one or more operation buttons. The customer LCD 102 displays various information items for customers. However, the display device should by no means be limited to LCDs, and any kind of display can apply.

Alternatively, the customer touch panel 101 and the customer LCD 102 may be in a combination, such as a display with touch panels or the like. Customers may perform input operations in accordance with the information on such a display with touch panels.

The automated teller machines 10a , 10b, and 10c comprise the clerk touch panels 108. However an inputting device should by no means be limited to a touch panel and various alternatives may be applied. The various information items for clerks are displayed on the clerk LCD 109. However, the display device should by no means be limited to LCDs, and any kind of display can be used.

Alternatively, the clerk touch panel 108 and the clerk LCD 109 may be in a combination, such as a display with a touch panel or the like. Clerks and managers may perform input operations in accordance with the information on such display with touch panels.

In these embodiments, the automated teller machines 10a, 10b and 10c respectively include hard disks 110 to store various data and programs. A storing device for such data and programs should by no means be limited to the hard disk 110, and alternatives, such as a memory, other than the hard disk may be included.

The charge counter 11 is included in the automated teller machine 10a in the first embodiment and in the information management server 30b in the second embodiment. The element that serves to function as the charge counter 11 should by no means be limited to be included in the automated teller machine 10a and the information management server 30b. Alternatively, the host computer 20 or a non-illustrated element communicably connected to the automated teller machine 10a, 10b, or 10c may serve as the charge counter 11 or 11c.

Further, the automated teller machines 10a, 10b, and 10c serve to function as the placement fee determination unit 12. Alternatively, the automated teller machine 10a , 10b, or 10c, the host computer 20 or a non-illustrated element communicably connected to the automated teller machine 10a, 10b, or 10c may serve to function as the placement fee determination unit 12.

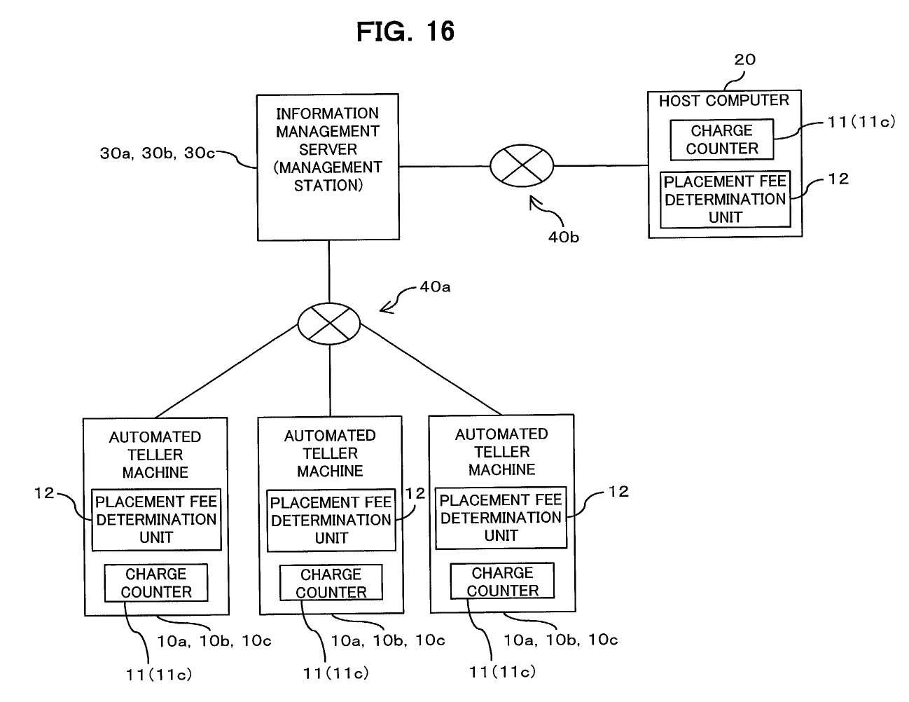

FIG. 16 schematically shows an automated teller system according to a modification of the present invention. Like reference numbers designate similar parts or elements throughout several views of different illustrated examples, so any repetitious description is omitted here.

As shown in FIG. 16, the host computer 20 may comprise the charge counter 11 or 11c, and the placement fee determination unit 12. Further, the automated teller machine 10a, 10b or 10c may comprise both the charge counter 11 or 11c, and the placement fee determination unit 12.

The manner of determination of a placement fee by the placement fee determination unit 12 should by no means be limited to that described above. Alternatively, a standard fee may have been determined in advance, and an additional rate or an additional fee be determined based on the electronic history information. For example, each piece of the electronic history information may be converted to points whereupon a placement fee is determined based on the points.

In the third embodiment, the web contents 114, the proxy server application 430 and the web server application 440 are stored in the information management server 30c, however these applications and contents should by no means be stored in the information management server 30c. At least part of these applications and contents may be stored in an external device or an external element communicably connected to the information management server 30c via the networks 40a and 40b and the Internet.

When the automated teller machines 10a, 10b and 10c are used by customers of a plurality of financial institutions, the placement fee determination unit 12 obtains information regarding which financial institution an individual customer has made transactions with, when making the individual transactions. After that, the automated teller machines 10a , 10b and 10c respectively examine the electronic history information regarding the individual financial institutions, and determine placement fees to be paid by the individual financial institutions based on the electronic history information with respect to the individual financial institution.

Throughout the specification, a manner of determination of placement fees for the automated teller machines 10a , 10b and 10c in the automated teller system 1a, 1b and 1c is described. However, the present invention may be used to determine a placement fee for automated transaction machines (e.g., cash dispensers of automated financial transaction machines) other than an automated teller machine. Further, the present invention may apply to determine placement fees for information terminals, vending machines, battery chargers for mobile telephones, and any other automated transaction apparatus.

What is claimed is:

1. An automated transaction machine (ATM) placement fee determination method for determining an ATM placement fee to be paid to a fee recipient entity in a nonbank location in which an ATM is installed under a payment-by-results contract with a service provider, comprising the steps of:
(a) obtaining electronic history information of the ATM; and
(b) determining the ATM placement fee, which is to be paid to the fee recipient entity, in a computer-implemented way based on said electronic history information obtained by said obtaining step (a).

2. An automated transaction machine (ATM) placement fee determination method according to claim 1, wherein said electronic history information is a transaction history about one or more transactions that have been performed on the ATM.

3. An automated transaction machine (ATM) placement fee determination method according to claim 2, wherein said transaction history is defined in terms of the number of transactions that have been performed on the ATM.

4. An automated transaction machine (ATM) placement fee determination method according to claim 2, wherein said transaction history is defined in terms of the total sum of money that has been transacted on the ATM during the individual transactions.

5. An automated transaction machine (ATM) placement fee determination method according to claim 2, wherein said transaction history is defined in terms of a combination of the number of transactions performed on the ATM and the total sum of money transacted on the ATM during the individual transactions.

6. An automated transaction machine (ATM) placement fee determination method according to claim 2, wherein said transaction history is defined in terms of the total length of time during which the ATM has been kept in proper condition for service.

7. An automated transaction machine (ATM) placement fee determination method according to claim 2, wherein said transaction history is defined in terms of a combination of the number of transactions performed on the ATM and the total length of time during which the ATM has been kept in proper condition for service.

8. An automated transaction machine (ATM) placement fee determination method according to claim 2, wherein said transaction history is defined in terms of a combination of the total sum of money that have been transacted on the ATM during the individual transactions and the total length of time during which the ATM has been kept in proper condition for service.

9. An automated transaction machine (ATM) placement fee determination method according to claim 2, wherein said transaction history is defined in terms of a combination of the number of transactions performed on the ATM, the total sum of money transacted on the ATM during the individual transactions, and the total length of time during which the ATM has been kept in proper condition for service.

10. An automated transaction machine (ATM) placement fee determination method according to claim 1, wherein said electronic history information is a browsing history about browsing web contents on the Internet as the ATM has been used by individual customers.

11. An automated transaction machine (ATM) placement fee determination method according to claim 1, wherein said electronic history information is a combination of a transaction history about one or more transactions performed on the ATM and a browsing history about browsing web contents on the Internet as the ATM has been used by individual customers.

12. An automated transaction machine (ATM) placement fee determination method according to claim 11, wherein said transaction history is defined in terms of the number of transactions that have been performed on the ATM.

13. An automated transaction machine (ATM) placement fee determination method according to claim 11, wherein said transaction history is defined in terms of the total sum of money that has been transacted on the ATM during the individual transactions.

14. An automated transaction machine (ATM) placement fee determination method according to claim 11, wherein said transaction history is defined in terms of a combination of the number of transactions performed on the ATM and the total sum of money transacted on the ATM during the individual transactions.

15. An automated transaction machine (ATM) placement fee determination method according to claim 1, wherein said electronic history information is defined in terms of a combination of the total length of time during which the ATM has been kept in proper condition for service and a browsing history about browsing web contents on the Internet as the ATM has been used by individual customers.

16. An automated transaction machine (ATM) placement fee determination method according to claim 11, wherein said transaction history is defined in terms of the total length of time during which the ATM has been kept in proper condition for service.

17. An automated transaction machine (ATM) placement fee determination method according to claim 11, wherein said transaction history is defined in terms of a combination of the number of transactions performed on the ATM and the total length of time during which the ATM has been kept in proper condition for service.

18. An automated transaction machine (ATM) placement fee determination method according to claim 11, wherein said transaction history is defined in terms of a combination of the total sum of money transacted on the ATM during the individual transactions and the total length of time during which the ATM has been kept in proper condition for service.

19. An automated transaction machine (ATM) placement fee determination method according to claim 11, wherein said transaction history is defined in terms of a combination of the number of transactions performed on the ATM, the total sum of money transacted on the ATM during the individual transactions, and the total length of time during which the ATM has been kept in proper condition for service.

20. An automated transaction machine (ATM) placement fee determination method according to claim 1, wherein said electronic history information is a maintenance history of one or more maintenance operations that have been performed by said fee reception entity.

21. An automated transaction machine (ATM) placement fee determination method according to claim 20, wherein said maintenance history is an item loading history of loading the ATM with a consumption item by said fee reception entity.

22. An automated transaction machine (ATM) placement fee determination method according to claim 20, wherein said maintenance history is a problem solving history of solving one or more problems, which arose with respect to the ATM, by said fee reception entity.

23. An automated transaction machine (ATM) placement fee determination method according to claim 20, wherein said maintenance history is a money loading history of loading the ATM with money by said fee reception entity.

24. An automated transaction machine (ATM) placement fee determination method according to claim 23, wherein said money loading history is defined in terms of the total number of banknotes that have been loaded in the ATM by said fee recipient entity.

25. An automated transaction machine (ATM) placement fee determination method according to claim 23, wherein said money loading history is defined in terms of the total sum of money that has been loaded in the ATM by said fee recipient entity.

26. An automated transaction machine (ATM) placement fee determination method according to claim 1, wherein said ATM is an automated financial transaction machine (AFTM).

27. A service providing system comprising:
(a) an automated transaction machine (ATM), installed in a nonbank location of a fee recipient entity under a payment-by-results contract with a service provider, for providing services to individual customers upon their requests in a computer-implemented way;
(b) a history information obtaining unit for obtaining electronic history information of said ATM; and
(c) an ATM placement fee determination unit, operatively connected with said history information obtaining unit, for determining an ATM placement fee, which is to be paid to said fee recipient entity, in a computer-implemented way based on said electronic history information obtained in said history information obtaining unit.

28. A service providing system according to claim 27, further comprising an ATM management station, communicably connected with said ATM through a communications network, for managing said ATM installed in said fee recipient entity, said ATM management station serving as said history information obtaining unit and said ATM placement fee determination unit.

29. A financing system comprising:
(a) an automated financial transaction machine (AFTM), installed in a nonbank location of a fee recipient entity under a payment-by-results contract with a financial institution, for performing an electronic financial transaction upon a customer's request;
(b) a history information obtaining unit for obtaining electronic history information of said AFTM; and
(c) an AFTM placement fee determination unit, operatively connected with said history information obtaining unit, for determining an AFTM placement fee, which is to be paid to said fee recipient entity, in a computer-implemented way based on said electronic history information obtained in said history information obtaining unit.

30. A financing system according to claim 29, further comprising an AFTM management station, communicably connected with said AFTM through a communications network, for managing said AFTM installed in said fee recipient entity, said AFTM management station serving as said history information obtaining unit and said AFTM placement fee determination unit.

31. An automated transaction machine (ATM), which is to be installed in a nonbank location of a fee recipient entity under a payment-by-results contract with a service provider, for providing services to customers upon their requests in a computer-implemented way, comprising:
(a) a history information obtaining unit for obtaining electronic history information of said ATM; and
(b) an ATM placement fee determining unit, operatively connected with said history information obtaining unit, for determining the ATM placement fee, which is to be paid to said fee recipient entity, in a computer-implemented way based on said electronic history information obtained by said history information obtaining unit.

32. An automated financial transaction machine (AFTM), which is to be installed in a nonbank location of a fee recipient entity under a payment-by-results contract with a financial institution, for performing a financial transaction upon a customer's request in a computer-implemented way, comprising:
(a) a history information obtaining unit for obtaining electronic history information of said AFTM; and
(b) an AFTM placement fee determining unit, operatively connected with said history information obtaining unit, for determining the AFTM placement fee, which is to be paid to said fee recipient entity, in a computer-implemented way based on said electronic history information obtained by said history information obtaining unit.

33. A recording medium in which a program for determining an automated transaction machine (ATM) placement fee to be paid to a fee recipient entity, in a nonbank location of which an ATM is installed under a payment-by-results contract with a service provider, is recorded, wherein said program instructs a computer to execute the following steps:
(a) obtaining electronic history information of said ATM; and
(b) determining the ATM placement fee, which is to be paid to said fee recipient entity, based on said electronic history information obtained by said obtaining step (a).
